(19) United States
(12) Patent Application Publication
(10) Pub. No.: US 2013/0277180 A1
(43) Pub. Date: Oct. 24, 2013

(54) BELT CONVEYER

(71) Applicant: NIPPON ELECTRIC GLASS CO., LTD., Shiga (JP)

(72) Inventors: Yasuo TERANISHI, Takashima-shi (JP); Michiharu ETA, Hikone-shi (JP); Takahide FUJII, Nagahama-shi (JP); Naotoshi INAYAMA, Nagahama-shi (JP)

(21) Appl. No.: 13/858,239

(22) Filed: Apr. 8, 2013

(30) Foreign Application Priority Data
Apr. 20, 2012 (JP) 2012-096614

(51) Int. Cl. B65G 23/00

(52) U.S. Cl. CPC B65G 23/00
USPC 198/834

(57) ABSTRACT

Provided is a belt conveyor (1), comprising: an endless belt (2) for conveying an article (5) loaded thereon in a conveying direction (B); and rotating wheels (3, 4) for stretching the endless belt (2) therearound, wherein the endless belt (2) comprises: a plurality of plate glasses (2a) arrayed apart from each other along the conveying direction (B); and a coupling member (2b) for coupling the plurality of plate glasses (2a) to each other, and wherein the coupling member (2b) has stretchability higher than stretchability of each of the plurality of plate glasses (2a).

### TECHNICAL FIELD

The present invention relates to a belt conveyor comprising an endless belt for conveying articles loaded thereon, and rotating wheels for stretching the belt therearound.

### BACKGROUND ART

As is well known, a belt conveyor is means for conveying materials, parts, and products, and at present, has been widely used for various purposes in, for example, assembly plants for industrial products. As the belt conveyor, there has been widely employed a type in which a belt which is an endless flexible conveyor belt is driven and pivoted while being stretched around rotating wheels (drive roller and driven roller) such as a pulley and a roller.

Specifically, for example, Patent Literature 1 discloses a belt conveyor including an endless belt made of a thermoplastic resin or a thermoplastic elastomer, and pulleys as rotating wheels for stretching the belt therearound. Further, Patent Literature 1 describes that the thermoplastic resin and the thermoplastic elastomer forming the belt include a vinyl chloride resin and a polyurethane elastomer.

### CITATION LIST

### Patent Literature

Patent Literature 1: JP 2011-121688 A

### SUMMARY OF INVENTION

### Technical Problems

By the way, the entire belt of the belt conveyor disclosed in Patent Literature 1 above is made of a resin or an elastomer, and hence has low hardness as a whole. Thus, there is a high risk in that the belt is deteriorated earlier due to, for example, flaws that are easily generated on the belt. Thus, for example, when hard materials are conveyed, or when articles are inspected with transmitted light beams, a problem of insufficient durability for long-term use arises.

In order to solve those problems, it may be appropriate to use materials having higher hardness for the belt. However, in such a case, strechability that is inherently required for belts of this type is insufficient, with the result that the belt may be broken by tension applied to the belt.

The present invention has been made in view of the circumstances described above, and it is a technical object thereof to prevent a belt from being broken by tension while avoiding generation of flaws on a surface of the belt by increasing hardness of a material for the belt.

### Solution to Problems

A belt conveyor devised to achieve the above-mentioned object comprises: an endless belt for conveying an article loaded thereon in a conveying direction; and rotating wheels for stretching the endless belt therearound. The endless belt comprises: a plurality of plate glasses arrayed apart from each other along the conveying direction; and a coupling member for coupling the plurality of plate glasses to each other. The coupling member has stretchability higher than stretchability of each of the plurality of plate glasses.

In such a configuration, the plurality of plate glasses are used as one of components of the endless belt, and hence hardness of a surface of the endless belt is increased. As a result, flaws are less liable to be formed, and deterioration of the endless belt is efficiently suppressed. In addition, when tension is applied to the endless belt, the coupling member having the strechability higher than the stretchability of the each of the plurality of plate glasses is stretched by being elastically deformed in proportion to a magnitude of the tension. With this, in the conveying direction, the tension applied to the endless belt with respect to deformation over a certain length is reduced, and hence application of excessive stress to the plurality of plate glasses arrayed on the endless belt can be avoided. As a result, brittle fracture of the plurality of plate glasses, which may be caused by the tension, is reliably prevented.

In the above-mentioned configuration, it is preferred that the coupling member be formed into an endless shape, and be applied along an end portion in a width direction of the each of the plurality of plate glasses, the width direction being orthogonal to the conveying direction.

With this, the coupling member exerts stretchability to function to correct a twist of the endless belt and a shift in the width direction of adjacent plate glasses, and hence the article can be stably conveyed. Further, application of excessive stress to the plurality of plate glasses provided to the endless belt, which may be caused by the shift and the twist, can also be avoided. With this, the brittle fracture of the plurality of plate glasses can be more reliably prevented.

In the above-mentioned configuration, it is preferred that a contact part of the endless belt with respect to each of the rotating wheels be formed of the each of the plurality of plate glasses.

With this, the contact part of the endless belt with respect to the each of the rotating wheel is formed of the plate glass having high hardness and flaw resistance, and hence generation of dust from the endless belt by sliding with respect to the rotating wheels can be appropriately suppressed.

Further, a belt devised to achieve the above-mentioned object is an endless belt for conveying an article loaded thereon in a conveying direction, and comprises: a plurality of plate glasses arrayed apart from each other along the conveying direction; and a coupling member for coupling the plurality of plate glasses to each other. The coupling member has stretchability higher than stretchability of each of the plurality of plate glasses.

When such an endless belt is stretched around the rotating wheels, the same functions and advantages as those in the above description of the belt conveyor can be provided.

In the above-mentioned configuration, it is preferred that the coupling member be formed into an endless shape, and be applied along an end portion in a width direction of the each of the plurality of plate glasses, the width direction being orthogonal to the conveying direction.

With this, the same functions and advantages as those in the above description of the belt conveyor can be provided.

### Advantageous Effects of Invention

As described above, according to the present invention, the hardness of the surface of the endless belt is increased. Thus, generation of flaws on the surface of the endless belt and deterioration of the endless belt that may be caused thereby can be efficiently avoided. In addition, deficiency in flexibility and stretchability in a case where hardness of the entire endless belt is increased is suppressed. Thus, the endless belt can be prevented from being broken by tension applied to the endless belt.

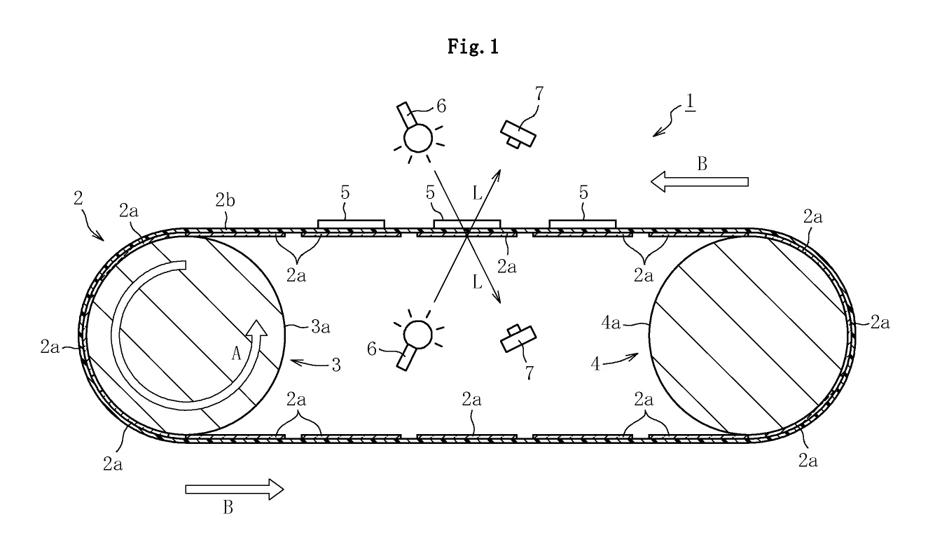

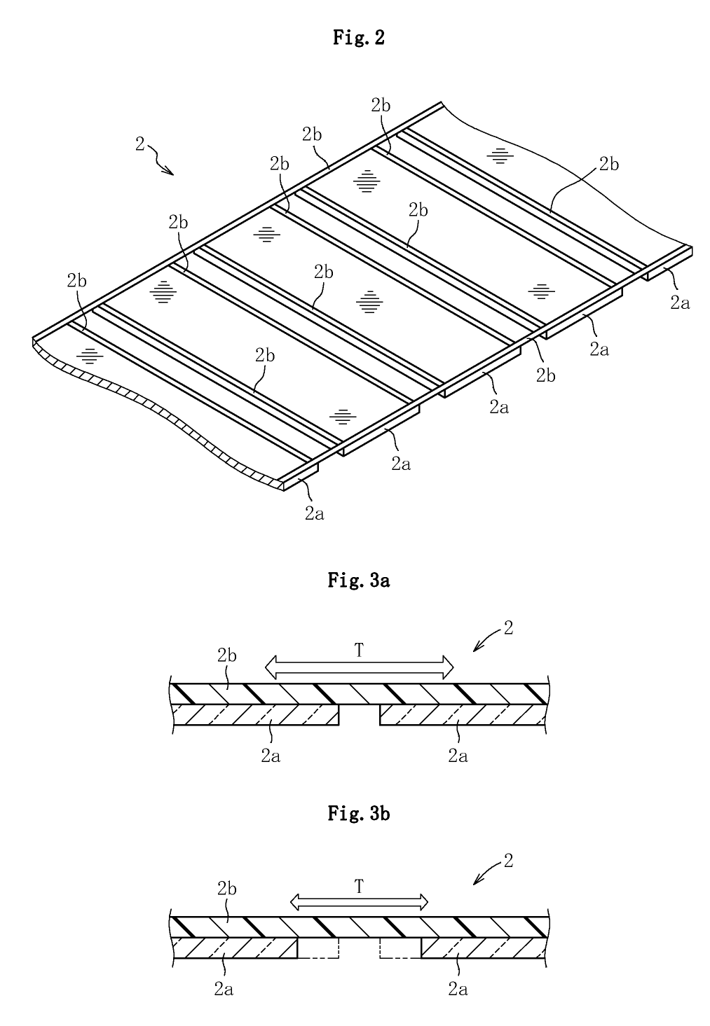

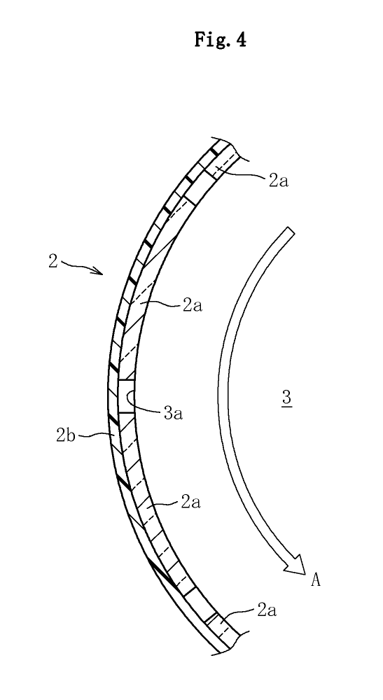

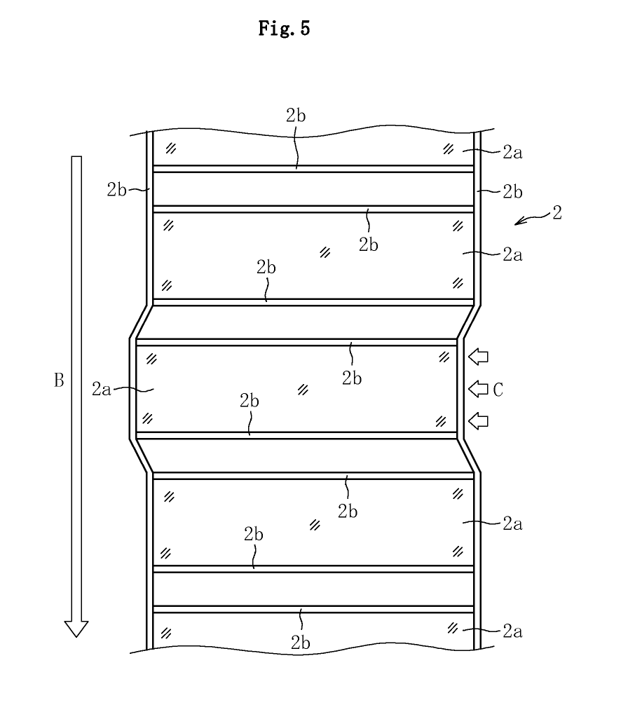

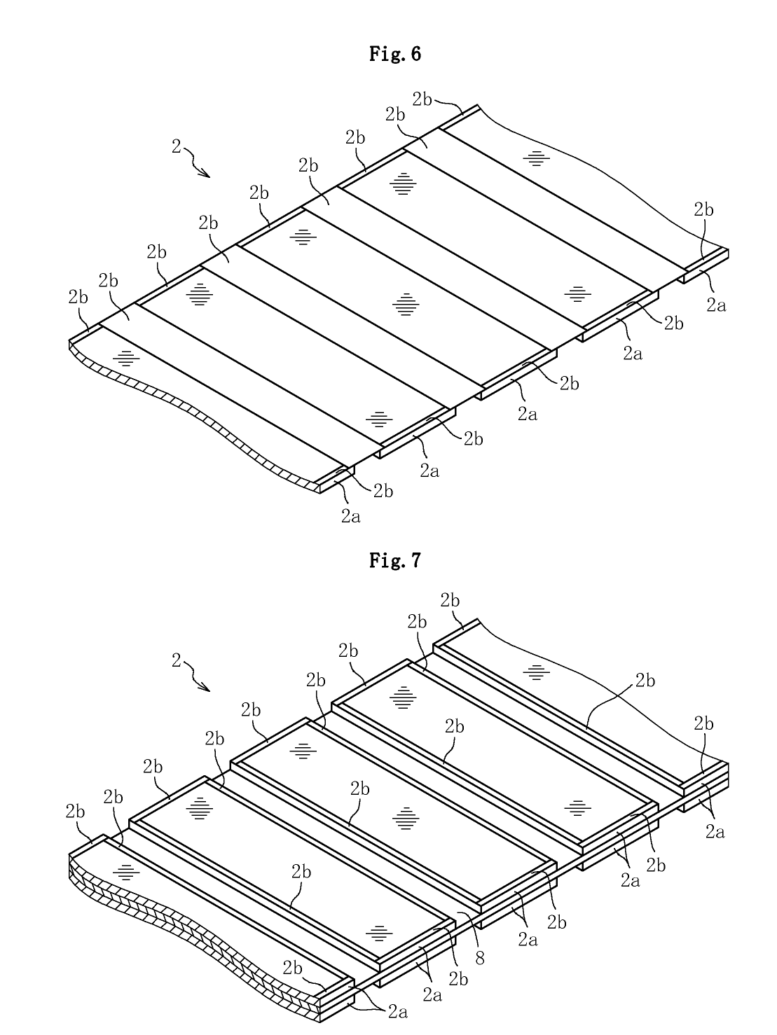

### BRIEF DESCRIPTION OF DRAWINGS

[FIG. 1] A side view of a belt conveyor according to a first embodiment of the present invention.

[FIG. 2] A perspective view of a belt provided to the belt conveyor according to the first embodiment of the present invention.

[FIG. 3a] A side view illustrating conveyance using the belt conveyor according to the first embodiment of the present invention.

[FIG. 3b] A side view illustrating the conveyance using the belt conveyor according to the first embodiment of the present invention.

[FIG. 4] A side view illustrating the conveyance using the belt conveyor according to the first embodiment of the present invention.

[FIG. 5] A plan view illustrating the conveyance using the belt conveyor according to the first embodiment of the present invention.

[FIG. 6] A perspective view of a belt provided to a belt conveyor according to a second embodiment of the present invention.

[FIG. 7] A perspective view of a belt provided to a belt conveyor according to a third embodiment of the present invention.

### DESCRIPTION OF EMBODIMENTS

In the following, description is made of embodiments of the present invention with reference to the attached drawings.

FIG. 1 is a side view of a belt conveyor 1 according to a first embodiment of the present invention. As illustrated in FIG. 1, the belt conveyor 1 comprises an endless belt 2 for conveying an article 5 loaded thereon in a conveying direction (direction B), a drive roller 3 and a driven roller 4 serving as rotating wheels for stretching the belt 2 therearound, light sources 6 for emitting light beams L that are transmitted through the belt 2 and the article 5, and cameras 7 for receiving the transmitted light beams L.

As illustrated in FIG. 2, the belt 2 comprises a plurality of plate glasses 2a and transparent resin tapes 2b as coupling members for coupling the plate glasses 2a to each other. The plurality of plate glasses 2a are each formed of a flexible thin rectangular plate glass, and arrayed apart from each other along the conveying direction (direction B) of the belt 2. On a front surface side of the plate glasses 2a (side on which the articles 5 are loaded), the resin tapes 2b are applied along edge portions continuous with end portions in the conveying direction, and edge portions continuous with end portions in a width direction orthogonal to the conveying direction. A pair of the resin tapes 2b applied along the edge portions in the width direction is formed into an endless shape along the conveying direction of the belt 2, and couples the plurality of plate glasses 2a to each other therealong. Further, the resin tapes 2b have stretchability higher than that of the plate glasses 2a. The resin tapes 2b are preferably made of PET.

The drive roller 3 is driven to rotate in a direction A illustrated in FIG. 1 by a motor (not shown), and has an outer peripheral surface 3a which is held in contact with the plate glasses 2a provided to the belt 2. With this configuration, the belt 2 is operated in the direction B by friction of the outer peripheral surface 3a and the plate glasses 2a. Note that, the driven roller 4 has the same structure as that of the drive roller 3 except that a driving force by the motor is not imparted.

The light beams L from the light sources 6 are radiated toward the articles 5 loaded on the belt 2, transmitted through the belt 2 and the articles 5, and received with the cameras 7. After that, the light beams L are converted into electrical signals, and then sent to a detection circuit and a determination circuit (none of which is shown). In this way, whether or not internal failures of the articles 5 exist is optically inspected.

In this case, a thickness of each of the plate glasses 2a preferably ranges from 1 μm to 500 μm, more preferably from 10 μm to 300 μm. Further, a clearance formed between adjacent plate glasses 2a is preferably 1 mm or more.

In the following, description is made of conveyance using the above-mentioned belt conveyor 1.

When the drive roller 3 is rotated in the direction A, the belt 2 is moved in the direction B by the friction of the outer peripheral surface 3a of the drive roller 3 and the plate glasses 2a provided to the belt 2. In this way, the articles 5 are conveyed. At this time, as illustrated in FIG. 3a, particularly high tension T is applied to a part of the belt 2 (tight side tension part), which is being moved in a direction from the driven roller 4 to the drive roller 3.

However, the resin tapes 2b have the stretchability higher than the stretchability of the plate glasses 2a. Thus, as illustrated in FIG. 3b, in contrast to the plate glasses 2a which are difficult to elastically deform, the resin tapes 2b are stretched by being elastically deformed in proportion to a magnitude of the tension T applied to the belt 2. Further, stretch per unit length in the conveying direction causes reduction in tension T applied to the belt 2, and hence application of excessive stress to the plate glasses 2a provided to the belt 2 can be avoided. As a result, brittle fracture of the plate glasses 2a, which may be caused by the tension T, is reliably suppressed.

Further, as illustrated in FIG. 4, when the belt 2 rolls around the drive roller 3, the plate glasses 2a provided to the belt 2 are thin and flexible, and hence the belt 2 smoothly rolls around the drive roller 3. In this case, stress in proportion to a curvature of the drive roller 3 is applied to the plate glasses 2a provided to the belt 2. Thus, for example, when the drive roller 3 has a small diameter and the outer peripheral surface 3a has a large curvature, excessive bending stress is applied to the plate glasses 2a, which may break the plate glasses 2a. However, the plate glasses 2a are arrayed apart from each other along the conveying direction (direction B), and coupled to each other with the elastically deformable resin tapes 2b applied therealong. Thus, such a risk is appropriately eliminated as described below.

Specifically, due to the stretchability of the resin tapes 2b, a curvature of the plate glasses 2a at the time when the belt 2 rolls around the drive roller 3 is reduced to an extent that the plate glasses 2a are not subjected to a bending failure. As a result, application of excessive stress to the plate glasses 2a is prevented. In this way, a situation such as breakage of the plate glasses 2a by the bending stress applied to the plate glasses 2a when the belt 2 rolls around the drive roller 3 is avoided as much as possible.

Further, the glass has high hardness and flaw resistance. Thus, it is possible to prevent deterioration in transmittance of the light beams L radiated from the light sources 6 with respect to the belt 2 due to flaws generated by sliding of the plate glasses 2a and the articles 5 and by sliding of the plate glasses 2a and the outer peripheral surface 3a of the drive roller 3. With this, the light beams L that are transmitted through the belt 2 and the articles 5 can be accurately received with the cameras 7. Thus, whether or not internal failures of the articles 5 exist can be satisfactorily inspected.

In addition, as illustrated in FIG. 5, even when the plate glass 2a is moved in a direction C and is shifted in position in the width direction with respect to adjacent plate glasses 2a, the pair of resin tapes 2b provided along the edge portions in the width direction functions to correct the shift. In addition, the resin tapes 2b also function to correct a twist of the belt 2. Thus, application of excessive stress to the plate glasses 2a, which may be caused by the shift and the twist, can also be avoided. As a result, the brittle fracture of the plate glasses 2a can be more reliably prevented.

Further, the belt 2 also has the following advantage. Specifically, the plate glasses 2a adjacent to each other are arrayed apart from each other and the resin tapes 2b are provided only on the front surface side of the plate glasses 2a, and hence generation of dust by collision or contact of the plate glasses 2a, or by sliding of the resin tapes 2b and each of the drive roller 3 and the driven roller 4 can be prevented. Thus, the belt 2 can be used without problems even in an environment requiring high air cleanliness, such as a clean room.

FIG. 6 is a perspective view of the belt 2 provided to the belt conveyor 1 according to a second embodiment of the present invention. Note that, in each of the drawings for illustrating belt conveyors according to second and third embodiments below, components common to those of the belt conveyor 1 according to the first embodiment described above are denoted by the same reference symbols so that description thereof is omitted.

The belt conveyor 1 according to the second embodiment is different from the belt conveyor 1 according to the first embodiment described above in that, in the belt 2, the resin tape 2b is applied to the entire region in the width direction of the belt 2 at a position between adjacent plate glasses 2a.

With this, the resin tape 2b is applied to the entire region in the width direction at the position between the adjacent plate glasses 2a, and hence shift in position in the width direction of the adjacent plate glasses 2a and the twist of the belt 2 are more reliably prevented. As a result, the articles 5 can be more stably conveyed. In addition, the resin tapes 2b each have a width larger than that in the first embodiment described above, and hence tensile stress applied to the resin tapes 2b is dispersed. As a result, a situation such as breakage of the belt 2 by rupture of the resin tapes 2b can be prevented.

FIG. 7 is a perspective view of the belt 2 provided to the belt conveyor 1 according to the third embodiment of the present invention. The belt conveyor 1 according to the third embodiment is different from the belt conveyor 1 according to the first embodiment described above in that the plurality of plate glasses 2a are provided on each of the front surface side and the back surface side of the belt 2, and an endless sheet member 8 as a coupling member is interposed between the plate glasses 2a on the front surface side and the plate glasses 2a on the back surface side. Note that, the sheet member 8 is made of a transparent resin, and hence has stretchability higher than that of the plate glasses 2a.

With this, for example, at the time of loading the articles 5, even when a situation in which the plate glasses 2a on an outer peripheral side (contact side with respect to the articles 5) are broken by collision against the articles 5 occurs, operation of the belt conveyor 1 can be restarted by replacing only the broken plate glasses 2a with new plate glasses 2a without removing the belt 2 from the belt conveyor 1.

Note that, the configuration of the belt conveyor according to the present invention is not limited to those described in the embodiments above. For example, the rotating wheel for stretching the belt therearound comprises not only the roller but also a pulley, a sprocket, and the like. Further, in each of the embodiments described above, as the coupling member, the sheet member formed of a resin tape or a resin is used. Examples of the materials which may be used include polyurethane, polypropylene, and the like, and various kinds of rubber.

Further, in each of the embodiments described above, the plurality of plate glasses are each formed into a rectangular shape, and arrayed in a manner that the end portions in the belt width direction of each of the plate glasses are parallel to the conveying direction of the belt. However, such an array need not necessarily be employed, and there may be employed any other array method as long as the plate glasses are arrayed apart from each other along the conveying direction. For example, the plurality of plate glasses maybe each formed into a square shape, and arrayed in a manner that one diagonal of each of the plate glasses is parallel to the conveying direction and another diagonal is parallel to the width direction.

Further, in the belt conveyor according to each of the embodiments described above, whether or not internal failures of the articles exist is optically inspected. However, the belt conveyor according to the present invention may be used for other purposes. For example, the loaded articles may be subjected to an etching process, heat treatment, and the like while being conveyed. This is because the plate glasses are provided as components of the belt, and hence the belt is excellent in heat resistance and chemical resistance in comparison with a belt made of a resin or an elastomer. In this case, the coupling member is not required to have optical transmittance, and hence the coupling member need not be transparent.

In addition, the resin tapes 2b are applied only to the front surface side of the belt 2 in each of the embodiments described above, but how to apply the resin tapes 2b is not limited thereto. For example, the resin tape 2b may be folded back at the end portion of the belt 2 so as to coat the end portion and the edge portions of the front and back surfaces, which are continuous with the end portion. Alternatively, the resin tapes 2b may comprise two resin tapes 2b for coating the edge portions of the front and back surfaces. Alternatively, the resin tapes 2b may comprise one or two resin tapes 2b to be applied along the end portions so as to coat the end portions. Also when the resin tapes 2b are applied in those ways, in comparison with conventional belts made of a resin or an elastomer, a contact part between the resin and each of the drive roller 3 and the driven roller 4 is markedly reduced in area. Thus, generation of dust from the sliding portion can be suppressed as much as possible.

### REFERENCE SIGNS LIST

1 belt conveyor
2 belt
2a plate glass
2b resin tape
3 drive roller
4 driven roller
5 article
6 light source
7 camera
8 sheet member

1. A belt conveyor, comprising:
an endless belt for conveying an article loaded thereon in a conveying direction; and
rotating wheels for stretching the endless belt therearound,
wherein the endless belt comprises:
a plurality of plate glasses arrayed apart from each other along the conveying direction; and
a coupling member for coupling the plurality of plate glasses to each other, and
wherein the coupling member has stretchability higher than stretchability of each of the plurality of plate glasses.

2. The belt conveyor according to claim 1, wherein the coupling member is formed into an endless shape, and is applied along an end portion in a width direction of the each of the plurality of plate glasses, the width direction being orthogonal to the conveying direction.

3. The belt conveyor according to claim 1, wherein a contact part of the endless belt with respect to each of the rotating wheels is formed of the each of the plurality of plate glasses.

4. An endless belt for conveying an article loaded thereon in a conveying direction, the endless belt comprising:
a plurality of plate glasses arrayed apart from each other along the conveying direction; and
a coupling member for coupling the plurality of plate glasses to each other,
wherein the coupling member has stretchability higher than stretchability of each of the plurality of plate glasses.

5. The endless belt according to claim 4, wherein the coupling member is formed into an endless shape, and is applied along an end portion in a width direction of the each of the plurality of plate glasses, the width direction being orthogonal to the conveying direction.

6. The belt conveyor according to claim 2, wherein a contact part of the endless belt with respect to each of the rotating wheels is formed of the each of the plurality of plate glasses.
